(19) United States
(12) Patent Application Publication
(10) Pub. No.: US 2012/0169951 A1
(43) Pub. Date: Jul. 5, 2012

(54) VERTICALLY ALIGNED LCDS AND METHODS FOR DRIVING THE SAME

(75) Inventors: Li-Wei Sung, Miao-Li County (TW); Chung-Yi Wang, Miao-Li County (TW); An-Chang Wang, Miao-Li County (TW); Yao-Lien Hsieh, Miao-Li County (TW)

(73) Assignee: Chimei InnoLux Corporation, Miao-Li County (TW)

(21) Appl. No.: 13/243,043

(22) Filed: Sep. 23, 2011

(30) Foreign Application Priority Data
Dec. 29, 2010 (TW) 99146539

(51) Int. Cl. G02F 1/133

(52) U.S. Cl. 349/33

(57) ABSTRACT

The disclosed are methods for driving a vertically aligned (VA) LCD. The VALCD has an array substrate, an opposite substrate, and a liquid crystal layer disposed therebetween. The array substrate includes a common line, the opposite substrate includes a common electrode layer, and the liquid crystal layer has a threshold voltage. The common line is applied a higher positive voltage and the common electrode layer is applied a lower positive voltage, such that negative impurities are adsorbed on the common line. As such, image sticking problems are reduced.

### CROSS REFERENCE TO RELATED APPLICATIONS

This Application claims priority of Taiwan Patent Application No. 099146539, filed on Dec. 29, 2010, the entirety of which is incorporated by reference herein.

### BACKGROUND OF THE INVENTION

1. Field of the Invention

The present invention relates to liquid crystal displays (LCD), and in particular relates to methods for driving the same.

2. Description of the Related Art

Two major methods for driving liquid crystal displays are twisted nematic (TN) mode and vertically aligned (VA) mode methods.

When the TN mode is selected, the liquid crystal of the liquid crystal display cannot rotate without an electrical field being applied thereto. As such, light travels from a backlight module to the eyes of viewers through the liquid crystal and a polarizer. The described phenomenon is a so-called “normally white” phenomenon, which means that the display shows a full white image without any electrical field being applied thereto. The TN mode LCDs have already dramatically advanced, technically, in recent years, and now provide higher contrast and color saturation than conventional displays such as CRT displays. However, the TN mode LCDs have a critical narrow viewing angle defect, and therefore its applications are limited.

When the VA mode is selected, the liquid crystal of the liquid crystal display cannot rotate without an electrical field being applied thereto. As such, light from a backlight module may travel through the liquid crystal and a bottom polarizer and then is blocked by a top polarizer. The described phenomenon is a so-called “normally black” phenomenon, which means that the display shows a full black image without any electrical field being applied thereto. Compared to the TN mode LCDs, the VA mode LCDs may display images of higher contrast, with faster response times, and with wider viewing angles. As a result, the VA mode LCDs are novel LCDs currently.

Unfortunately, image sticking problems easily occur in VA mode LCDs due to ion aggregation of direct current residue; especially when VA mode LCDs are displayed for a long-time or for certain types of images. The general method for solving the image sticking problem is to reduce a particular pollutant occurring during the manufacturing process. However, even the cleanest clean room or equipment still contains some particles. In other words, the image sticking phenomenon in the VA mode LCDs is a timing problem which can not be avoid. Accordingly, a novel method is called for to solve the image sticking problem without dramatically changing current LCD structural designs.

### BRIEF SUMMARY OF THE INVENTION

One embodiment of the disclosure provides a method for driving a vertically aligned liquid crystal display, comprising: providing a vertically aligned liquid crystal display, wherein the vertically aligned liquid crystal display comprises an array substrate, an opposite substrate, and a liquid crystal layer interposed between the array substrate and the opposite substrate, and wherein the array substrate comprises a common line, the opposite substrate comprises a common electrode layer, and the liquid crystal layer has a threshold voltage; and applying a first positive voltage to the common line of the array substrate, and applying a second positive voltage to the common electrode layer of the opposite substrate, respectively, wherein the first positive voltage is higher than the second positive voltage.

One embodiment of the disclosure provides a vertically aligned liquid crystal display, comprising: an array substrate, an opposite substrate, and a liquid crystal layer interposed between the array substrate and the opposite substrate, wherein the array substrate comprises a common line, the opposite substrate comprises a common electrode layer, and the liquid crystal layer has a threshold voltage, wherein the common line of the array substrate is connected to a first positive voltage, and the common electrode layer of the opposite substrate is connected to a second positive voltage, respectively, and wherein the first positive voltage is higher than the second positive voltage.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a diagram showing impurities aggregated in a pixel region of an VA mode LCD in related art; and

FIG. 2 is a diagram showing impurities aggregated in regions other than the pixel region of an VA mode LCD in one embodiment of the disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

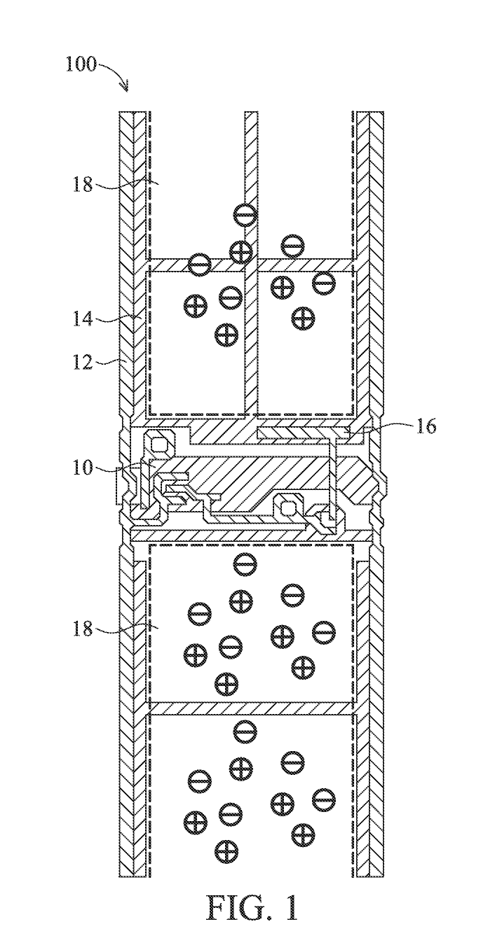

FIG. 1 shows a partial top-view of an array substrate 100 of one embodiment of the invention. The array substrate 100 comprises gate lines 10 connecting to gate electrodes of thin film transistors, data lines 12 connecting to source electrodes of the thin film transistors, and common lines 14 serving as bottom electrodes of storage capacitors 16. The gate lines 10 and the data lines 12 vertically cross each other for defining pixel regions 18. The array substrate 100 may collocate with a color filter substrate (not shown) and a liquid crystal layer (not shown) interposed therebetween, to form a VA mode LCD. The liquid crystal layer can be made of general nematic liquid crystals to meet the VA mode requirement. In one embodiment, the liquid crystal layer has a threshold voltage of 100 mV to 1500 mV, and the threshold voltage depends on the layout and power of the array substrate 100. In other embodiments, the relative locations of the gate lines 10, the data lines 12, the common lines 14, and the pixel regions 18 of the array substrate 100 can be designed in other manners and are not limited to those shown in FIG. 1. The driving method described below can be applied to all VA mode LCDs.

The VA mode LCD can be a transmissive, reflective, or transflective LCD, and the composition of a pixel electrode layer of the pixel region 18 would be different for each type. When the VA mode LCD istransmissive, a backlight module can be located under the array substrate or on the color filter substrate if necessary. When the VA mode LCD is transflective, a backlight module can be only located under the array substrate. It is understood that the VA mode LCD does not need any backlight module if it is reflective.

In the described embodiment, one side of the liquid crystal display is the array substrate 100, and the opposite substrate of the array substrate is the color filter substrate. However, the disclosure can be applied to a color filter on array (COA) substrate or an array on color filter (AOC) substrate. In another embodiment, the color filter layer is disposed between the circuit and the substrate of the array substrate to form the AOC substrate. Alternatively, the color filter layer is disposed on the array substrate to form the COA substrate. If the AOC substrate or the COA substrate is selected, a transparent substrate containing the common electrode layer can serve as an opposite substrate of the AOC substrate or the COA substrate.

In conventional VA mode LCDs, a voltage applied to the common line 14 is similar to another voltage applied to the common electrode layer (not shown) of the opposite substrate, e.g. between 5V to 8V. As described above, the VA mode LCD is naturally black when no voltage is applied thereto. Generally, some pixel regions may be damaged during the manufacturing process of the LCDs. Because the human eye is more sensitive to bright spots than to dark spots, damaged pixel regions can be repaired by breaking circuits thereof As such, the connection between the damaged pixel regions and main circuits are broken. The damaged pixel regions will be always be in a dark state after repair, no matter how high or low a voltage is, when applied to the LCD.

As shown in FIG. 1, impurities carrying positive charges (⊕) and impurities carrying negative charges (⊖) will aggregate in the pixel region 18 after the LCD is used for a long-time. This aggregation is irreversible, which is the so-called image sticking problem.

In one embodiment, a positive voltage applied to the common electrode 14 of the array substrate 100 is higher than another positive voltage applied to the common electrode layer (not shown) of the color filter substrate to overcome the described problem. In one embodiment, the difference between the two positive voltages must be lower than the threshold voltage of the liquid crystal layer, otherwise the damaged pixel regions will always be in the bright state, which reduces the display quality even after repair. In another embodiment, the difference between the two positive voltages should be greater than 100 mV, otherwise the problem of image sticking cannot be mitigated.

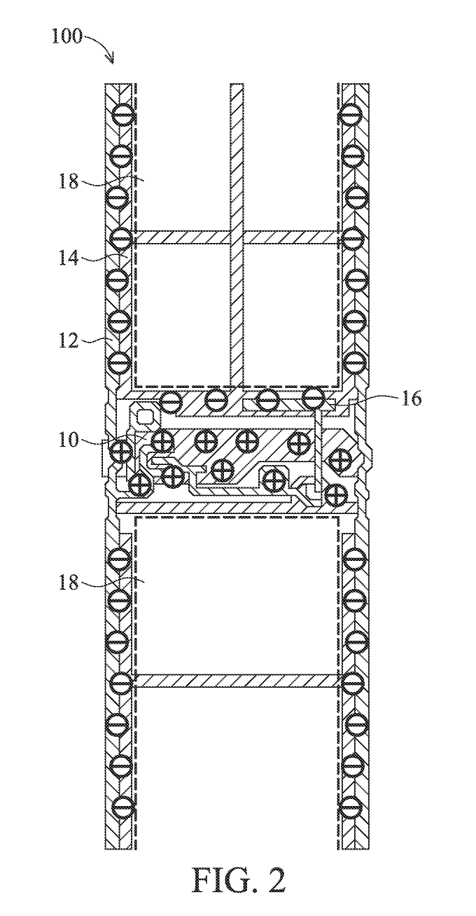

Because the positive voltage applied to the common electrode 14 of the array substrate 100 is higher than the other positive voltage applied to the common electrode layer (not shown) of the color filter substrate, a fixed voltage difference will be produced between the substrates. As shown in FIG. 2, the impurities carrying positive charges (⊕) will be adsorbed on the gate line 10 due to negative voltages being applied to the gate line 10 for a majority of the time during displaying images. On the other hand, positive voltages applied to the common line 14 of the array substrate 100 are higher than the other positive voltages applied to the common electrode layer of the color filter substrate, thus, the impurities carrying negative charges will be adsorbed on the common line 14, as shown in FIG. 2. Therefore, even if a large amount of particles are left after usage for a long-time and/or following the manufacturing processes, the impurities carrying the positive charges (⊕) and the impurities carrying the negative charges (⊖) will not aggregate in the pixel region 18.

Accordingly, the disclosure only applies different positive voltages to the common line 14 of the array substrate and the common electrode layer of the color filter substrate, respectively, such that the image sticking problem can be mitigated without largely changing conventional designs or materials for VA mode LCDs.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for driving a vertically aligned liquid crystal display, comprising:
providing a vertically aligned liquid crystal display, wherein the vertically aligned liquid crystal display comprises an array substrate, an opposite substrate, and a liquid crystal layer interposed between the array substrate and the opposite substrate, and wherein the array substrate comprises a common line, the opposite substrate comprises a common electrode layer, and the liquid crystal layer has a threshold voltage; and
applying a first positive voltage to the common line of the array substrate, and applying a second positive voltage to the common electrode layer of the opposite substrate, respectively,
wherein the first positive voltage is higher than the second positive voltage.

2. The method as claimed in claim 1, wherein the opposite substrate comprises a color filter substrate.

3. The method as claimed in claim 1, further comprising a color filter layer overlying or underlying the array substrate, forming a color filter on array (COA) substrate or an array on color filter (AOC) substrate.

4. The method as claimed in claim 1, wherein the first and second positive voltages have a voltage difference less than the threshold voltage of the liquid crystal layer.

5. The method as claimed in claim 1, wherein the first and second positive voltages have a voltage difference greater than 100 mV.

6. A vertically aligned liquid crystal display, comprising:
an array substrate, an opposite substrate, and a liquid crystal layer interposed between the array substrate and the opposite substrate, wherein the array substrate comprises a common line, the opposite substrate comprises a common electrode layer, and the liquid crystal layer has a threshold voltage,
wherein the common line of the array substrate is connected to a first positive voltage, and the common electrode layer of the opposite substrate is connected to a second positive voltage, respectively, and
wherein the first positive voltage is higher than the second positive voltage.

7. The vertically aligned liquid crystal display as claimed in claim 6, wherein the opposite substrate comprises a color filter substrate.

8. The vertically aligned liquid crystal display as claimed in claim 6, further comprising a color filter layer overlying or underlying the array substrate, forming a color filter on array (COA) substrate or an array on color filter (AOC) substrate.

9. The vertically aligned liquid crystal display as claimed in claim 6, wherein the first and second positive voltages have a voltage difference less than the threshold voltage of the liquid crystal layer.

10. The vertically aligned liquid crystal display as claimed in claim 6, wherein the first and second positive voltages have a voltage difference greater than 100 mV.
